(19) United States
(12) Patent Application Publication
(10) Pub. No.: US 2024/0278047 A1
(43) Pub. Date: Aug. 22, 2024

(54) MAGNETIC SAFETY MASK

(71) Applicant: Gloria J. Kelly, San Antonio, TX (US)

(72) Inventor: Gloria J. Kelly, San Antonio, TX (US)

(21) Appl. No.: 18/111,168

(22) Filed: Feb. 17, 2023

Related U.S. Application Data
(60) Provisional application No. 63/361,345, filed on Dec. 17, 2021.

(51) Int. Cl. A62B 18/08; A41D 13/11

(52) U.S. Cl. CPC A62B 18/086; A41D 13/1161

(57) ABSTRACT

A face mask that covers at least the nose and mouth openings of a user. The face mask includes a body and one or more straps for securing the facemask to the head of the user. The body includes a support portion and a central portion, wherein the central portion is circumscribed by the support portion. The central portion is made from porous material, such as polypropylene, and is dome shaped. The central portion further has an opening for receiving a straw.

### CROSS-REFERENCE TO RELATED APPLICATIONS

This application claims priority from a U.S. provisional patent application Ser. No. 63/361,345 filed on Dec. 17, 2021, which is incorporated herein by reference in its entirety.

### FIELD OF INVENTION

The present invention relates to a face mask and more particularly, the present invention relates to a magnetic safety mask that covers at least the nose and mouth of a wearer for filtering the breathing air.

### BACKGROUND

Face masks are commonly used around the world for a variety of reasons. The primary reason for covering the nose and mouth using a face mask is to retain certain particulate matter suspended in the air while breathing. The particles in both the inhaled air and exhaled air can be retained by the fabric of the face mask. The face mask has pores that allow particles of size less than the pore size to pass through but retains the particles larger in size. Based on the pore size, different face masks are commercially available. The particles can be pollen, dust, microbes, viruses, and the like. A face mask can protect a wearer of the face mask from inhaling microbes as well as from releasing the microbes into the environment.

Besides having the advantage of protecting the wearer from inhaling contaminants and microbes, wearing face masks for a longer duration can be uncomfortable for many.

Moreover, the known face mask may not fit properly over the face. Also, the user may have to remove the face mask while drinking or eating, and during this time, the person is exposed to contaminants as well as exhaling microbes if the person is already infected. Also, placing a dirty face mask on a table and the like may spread the contaminants from the face mask or to the face mask.

A need is therefore appreciated for improvements in the face mask.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a face mask for covering at least a nose and mouth and that overcomes the aforementioned problems and limitations with the face masks.

It is an object of the present invention that the face mask has improved filtering efficiency.

It is another object of the present invention that the face mask allows drinking without removing the face mask.

It is still another object of the present invention that the face mask allows eating small food products without removing the face mask.

It is yet another object of the present invention that the facemask is comfortable to wear.

It is a further object of the present invention that the facemask has a good amount of inner space for comfortable breathing and speaking.

It is still a further object of the present invention that the face mask does not stick to the nose or lips while breathing or speaking.

In one aspect, disclosed is a face mask that covers at least a nose opening and a mouth opening of a user, the face mask comprises a body; and one or more straps for securing the facemask to a head of the user, wherein the body comprises a support portion, a top of the support portion flex over a nose bridge of the user, a bottom of the support portion flex over a chin, and sides of the support portion cover the cheeks; and a central portion circumscribed by the support portion, the central portion made from a porous material, and the central portion is dome shaped. The one or more straps comprise two straps. The porous material is polypropylene fabric. The central portion comprises an opening, the opening configured to receive at least a straw. The central portion further comprises a frame circumscribing the opening, wherein a flap is coupled to the frame, the flap is configured to be flipped between an open state and a closed state, wherein the opening is accessible in the open state, wherein the opening is closed is the closed state. The frame is positioned near the bottom of the support portion such that a food product or the straw is received into the mouth opening through the opening. The frame and the flap further comprise magnets for removably attaching the flap to the frame in the open state. The frame and the magnets are configured to hold a magnetic straw inserted into the opening. The flap is configured to slide within the frame between the open state and the closed state. The flap is configured to pivot relative to the frame between the open state and the closed state. The flap is configured to sealably close the opening in the closed state.

### BRIEF DESCRIPTION OF THE DRAWINGS

The accompanying FIGURES, which are incorporated herein, form part of the specification and illustrate embodiments of the present invention. Together with the description, the FIGURES further explain the principles of the present invention and enable a person skilled in the relevant arts to make and use the invention.

FIG. 1 is a schematic view of the face mask showing different features, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a face mask that can cover at least the nose and mouth of a wearer. The disclosed face mask by having multiple layers of polypropylene fabric provides better filtration efficiency and longer use life. The disclosed face mask has a contoured design that allows the face mask to fit over the face from six sides providing better protection and comfort. Moreover, the disclosed facemask, because of its unique shape and size has enough inner space to allow a person to comfortably speak and breathe. The body of the face mask may not touch the lips while speaking. The close fit of the disclosed face mask over the nose and mouth prevents the formation of gaps through which unfiltered air may pass through. For example, the fogging of glasses due to exhaled air from gaps in the conventional face mask around the nose can be effectively prevented by the close fit of the disclosed face mask. The innovative structure of the disclosed face mask provides a close fit around the nose.

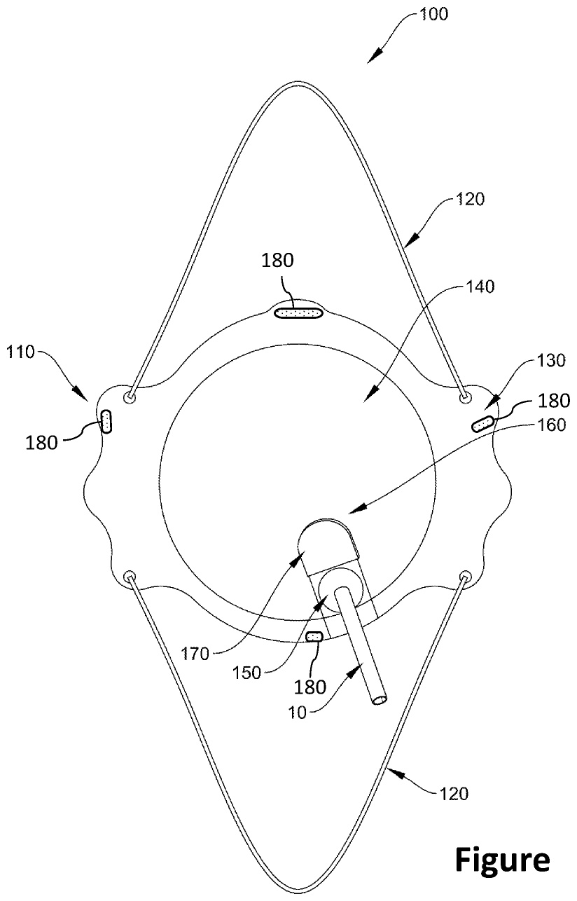

Referring to FIG. 1 shows an exemplary embodiment of the disclosed face mask. The face mask 100 has a body 110 and a pair of straps 120 that extend from opposite sides of the body for securing the facemask to the face of a wearer. The straps can be made from elastic or non-elastic materials. Also, instead of two separate straps, a single strap can be provided with the opposite ends of the single strap coupled to opposite sides of the body of the face mask, the opposite sides may be along a longitudinal axis or a traverse axis of the body of the face mask. Preferably, the straps can be made from suitable materials that are skin friendly. Optionally, the straps can also have sweat-wicking properties. When made from an elastic material, the elasticity may be enough to keep the face mask secured to the face without pinching or causing discomfort. In certain implementations, one or both straps can be provided with a length adjustment mechanism. Also, a suitable fastener can be provided to couple the two ends of the straps securing the face mask. The length adjustment mechanism and the fastener can be either integral or separate from the two straps. It is understood that when a single strap is used, the single strap can also have a length adjustment mechanism. The straps can go over the ears i.e., sidewards or over the head; FIG. 1 shows the two straps for passing over the head.

The body of the facemask can at least have multiple layers of polypropylene fabric that provide enhanced air filtration capabilities and efficiency. The use of polypropylene fabric also allows the face mask to have a specific shape. The face mask can be reusable several times, wherein the use of polypropylene fabric enhances the life of the face mask. It is understood that the face mask can have additional layers known to a skilled person for use in conventional face masks, such as a charged material layer to filter minute particles including viruses, and a wicking layer to absorb sweat.

The body of the face mask can include a support portion 130 of a shape as shown in the FIGURE. The top of the support portion can flex over the nose bridge, the bottom of the support portion can flex over the chin, and the sides of the support portion can cover the cheeks. The shape and dimension of the support portion provide a contoured fit shape that fits over the face from all six sides. The support portion can have a thinner hollow profile that surrounds the nose and mouth of the wearer. The support portion can be made from lightweight material, such as plastic. The material of the support portion can have suitable resiliency for comfort and close fit. The straps may be coupled to the support portion at the left and right sides thereof.

The body of the facemask further includes a central portion 140 circumscribed by the support portion. The central portion can be made from porous materials for air filtration as described above, such as polypropylene fabric. The air can be inhaled and exhaled through the central portion. The central portion can be dome-shaped which provides a good amount of breathing space. The dome shape central portion does not touch to nose and mouth of the user; thus, the user can remain comfortable, and the user can easily speak and breathe, and the facemask does not touch the mouth of the user while speaking which may otherwise cause wetting of the facemask. Moreover, the central portion can be flexible but has a suitable degree of rigidity (semi-rigid) that prevents the dome-shaped central portion from collapsing when breathing. The central portion does not stick to the nose while inhaling which makes the face mask super comfortable to wear for longer durations.

As shown in the drawings, the support portion can extend from the nose to under the eyes and down from the cheekbones to the jawbone under the chin for the contour secure fit shape.

The central portion can have an opening 150 for receiving a straw 10. Surrounding the opening can be a frame 160, wherein the frame can have a flap 170. The flap can be switched between a closed state and an open state. In the closed state, the flap can cover the opening while in the open state, the opening is accessible to receive the straw. Through the opening, small portions of a food product can also be inserted for eating.

The flap closes the opening in the closed state, wherein in the closed state, any ingress of air or moisture can be impeded. In one case, the flap can slide within the frame for switching between the closed state and the open state. Alternatively, the flap can pivot between the closed state and the open state. In one implementation, magnets can be coupled to the frame and flap, such that a magnetic straw can be magnetically retained within the opening. The opening allows the user to drink without removing the face mask. In one case, the inner side of the flap can be provided with a magnet and another magnet can be provided on the inner surface of the support portion or the central portion, or the frame, wherein the flap can be magnetically retained. FIG. 1 shows three magnets 180.

In one aspect, the size of the body of the disclosed facemask can be customized based on the size of the head, such as different size face masks can be provided for children, men, and women. In one case, the size of the face mask can be about 5 inches from the nose side to the chin side of the face mask. The size from the cheekbone to the jawbone can be about 1-5.5 inches such as to allow space for comfortably speaking and breathing.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A face mask that covers at least a nose opening and a mouth opening of a user, the face mask comprises:
a body; and
one or more straps for securing the facemask to a head of the user,
wherein the body comprises:
a support portion, a top of the support portion flex over a nose bridge of the user, a bottom of the support portion flex over a chin, and sides of the support portion cover the cheeks; and
a central portion circumscribed by the support portion, the central portion made from a porous material, and the central portion is dome shaped.

2. The face mask according to claim 1, wherein the one or more straps comprise two straps.

3. The face mask according to claim 1, wherein the porous material is polypropylene fabric.

4. The face mask according to claim 1, wherein the central portion comprises an opening, the opening configured to receive at least a straw.

5. The face mask according to claim 4, wherein the central portion further comprises:
a frame circumscribing the opening, wherein a flap is coupled to the frame, the flap is configured to be flipped between an open state and a closed state, wherein the opening is accessible in the open state, wherein the opening is closed is the closed state.

6. The face mask according to claim 5, wherein the frame is positioned near the bottom of the support portion such that a food product or the straw is received into the mouth opening through the opening.

7. The face mask according to claim 5, wherein the frame and the flap further comprise magnets for removably attaching the flap to the frame in the open state.

8. The face mask according to claim 7, wherein the frame and the magnets are configured to hold a magnetic straw inserted through the opening.

9. The face mask according to claim 5, wherein the flap is configured to slide within the frame between the open state and the closed state.

10. The face mask according to claim 5, wherein the flap is configured to pivot relative to the frame between the open state and the closed state.

11. The face mask according to claim 5, wherein the flap is configured to sealably close the opening in the closed state.
